(19) United States
(12) Patent Application Publication
(10) Pub. No.: US 2013/0188825 A1
(43) Pub. Date: Jul. 25, 2013

(54) IMAGE RECOGNITION-BASED STARTUP METHOD

(71) Applicant: Chia-Chun Tsou, New Taipei City (TW)

(72) Inventor: Chia-Chun Tsou, New Taipei City (TW)

(73) Assignee: UTECHZONE CO., LTD., New Taipei City (TW)

(21) Appl. No.: 13/353,368

(22) Filed: Jan. 19, 2012

(51) Int. Cl. G06K 9/62

(52) U.S. Cl. 382/103

(57) ABSTRACT

An image recognition-based startup method is provided. The startup method includes the steps of: generating a movement image signal; generating a behavior recognition signal; and performing a startup of an information apparatus. An image recognition unit performs behavior recognition on the movement image signal generated from a capturing unit. Then, the image recognition unit generates a startup control signal to instruct the information apparatus to perform a startup action. Users can start up or restart the information apparatus by performing behaviors such as shaking one's head, opening one's eyes, closing one's eyes, or blinking

### BACKGROUND OF THE INVENTION

1. Technical Field

The present invention relates to image recognition-based startup methods, and more particularly, to a method for use in an image recognition device. The method enables the device to be started up, configured, or shut down efficiently and quickly when it is impossible for a monitor and a keyboard to be installed on the device in an operating environment of the device.

2. Description of Related Art

Due to the advancement of image recognition technology, image recognition devices can operate in plenty of environments. Before the commencement of the operation of an image recognition device, it is usually necessary for a user to press a switch for triggering a startup and configure one or more detection regions. According to the prior art, an image recognition device is equipped with peripherals, such as a monitor (i.e., a displaying means), a mouse, a keyboard, or a touchscreen (i.e., an inputting means), but in certain circumstances, such as inside a vehicle, spatial limitations preclude the installation of a mouse, a keyboard, and a monitor. However, nowadays the aforesaid spatial limitations are circumvented, thanks to image recognition technology whereby users can start up, configure, or shut down an image recognition device without touching/pressing a physical button and a monitor.

Taiwan published patent application 201111686 discloses an image recognition switch device comprising a labeling device, a lens, a storage unit, an image recognition processing unit, a central processing unit, a switch control device, and a recognition processing startup device. With the aforesaid devices, once a user enters an image recognition sensing region of the image recognition switch device, the lens will be instantly started by the recognition processing startup device so as to perform an image capturing process. Once the user comes into contact with the labeling device, the lens will instantly capture the user's body image and send the body image to the image recognition processing unit. After receiving the body image, the image recognition processing unit compares the received body image with the control images stored in the storage unit. Upon determination that the body image matches one of the control images, the image recognition processing unit sends a control signal to the central processing unit, such that the central processing unit drives the switch control device to start up or shut down according to a driving signal. Alternatively, the image recognition processing unit emits an analog or digital regulating signal for controlling the brightness of a lamp.

Taiwan published patent application 201111686 discloses that a user delivers an intended message to a labeling device which bears the word “on” or “off”, for example, and then the user's intent is judged by means of image recognition, so as to turn on or turn off a lamp. Given the support lent by the labeling device, image recognition is rendered easy. Taiwan published patent application 201111686 teaches the necessity of a special label and requires touching the special label by hand, and thus has drawbacks as follows: it is inconvenient for physically handicapped persons or disabled persons to deliver their intended messages to a labeling device by their upper or lower limbs; and the labeling device serves a startup or shutdown function, but not a configuration function. Accordingly, it is imperative to provide a simple efficient image recognition method for starting up, configuring, or shutting down a device.

### SUMMARY OF THE INVENTION

The present invention relates to an image recognition-based startup method. The startup method comprises the steps of: generating a movement image signal; generating a behavior recognition signal; and performing an apparatus startup. The objective of the present invention is to enable users to start up and configure an information apparatus by performing behavior actions, such as shaking one's head, opening one's eyes, closing one's eyes, or blinking.

The present invention provides an image recognition-based startup method for use in an information apparatus having an image recognition system, the image recognition system comprising a capturing unit and an image recognition unit electrically connected to an output end of the capturing unit, the startup method comprising the steps of: generating a movement image signal, including capturing a user's behavior action by the capturing unit to generate a movement image signal; generating a behavior recognition signal, including reading the movement image signal by the image recognition unit and performing behavior recognition on the movement image signal to generate a startup control signal; and performing an apparatus startup, including reading the startup control signal by the information apparatus to instruct the information apparatus to perform a startup action.

Implementation of the present invention at least involves inventive steps as follows:

1. start up an information apparatus by performing behavior actions, such as shaking one's head, opening one's eyes, closing one's eyes, or blinking; and

2. perform boot startup, configuration, or awakening startup of an information apparatus by means of action image recognition only.

Hereinafter, the detailed features and advantages of the present invention are described in detail by way of the preferred embodiments of the present invention so as to enable persons skilled in the art to gain insight into the technical disclosure of the present invention, implement the present invention accordingly, and readily understand the objectives and advantages of the present invention by making reference to the disclosure of the specification, the claims, and the drawings of the present invention.

### BRIEF DESCRIPTION OF THE DRAWINGS

FIG. 1 is a flow chart of an image recognition-based startup method according to an embodiment of the present invention;

FIG. 2 is a system block diagram of an information apparatus having an image recognition system according to an embodiment of the present invention;

FIG. 3 is a schematic view of a user's behavior action range defined as a head-shaking range according to an embodiment of the present invention;

FIG. 4A is a schematic view of a user's behavior action range defined as a blinking range according to an embodiment of the present invention; and

FIG. 4B is another schematic view of a user's behavior action range defined as a blinking range according to an embodiment of the present invention.

### DETAILED DESCRIPTION OF THE INVENTION

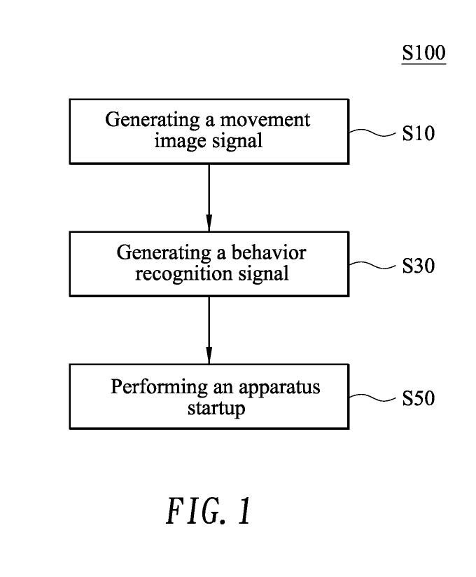

Referring to FIG. 1, in this embodiment, an image recognition-based startup method (step S100) comprises the steps of: generating a movement image signal (step S10); generating a behavior recognition signal (step S30); and performing an apparatus startup (step S50).

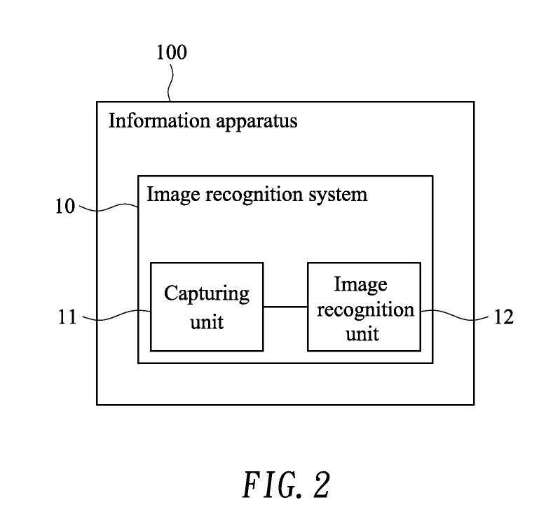

Referring to FIG. 2, in this embodiment, the image recognition-based startup method (step S100) is executed in an information apparatus 100 having an image recognition system 10. The information apparatus 100 is a nap zapper, a cell phone, a TV set, or a computer. The image recognition system 10 comprises at least a capturing unit 11 and an image recognition unit 12.

The capturing unit 11 is a camcorder for capturing an image of a user using the information apparatus 100. When the information apparatus 100 is a nap zapper or a cell phone, the capturing unit 11 is a built-in mini camcorder or camera. When the information apparatus 100 is a TV set, the capturing unit 11 is a built-in or external mini camcorder. When the information apparatus 100 is a computer, the capturing unit 11 is a built-in video module. Furthermore, the capturing unit 11 operates in a low-power standby mode to save power or operates in a normal mode for performing a high-resolution image-capturing process.

The image recognition unit 12 is electrically connected to an output end of the capturing unit 11. The image recognition unit 12 is image recognition software for processing a signal generated from the capturing unit 11 by means of computation performed by a microprocessor. The signal comprises consecutive invariable images or consecutive variable images. When the signal generated from the capturing unit 11 comprises consecutive invariable images, the image recognition unit 12 analyzes a result of the invariability of the images and then feeds back the result to the capturing unit 11 to cause it to maintain a low-power standby mode. When the signal generated from the capturing unit 11 comprises consecutive variable images, the image recognition unit 12 analyzes a result of the variability of the images and then feeds back the result to the capturing unit 11 to cause it to return to a normal mode for performing a high-resolution image-capturing process so as to facilitate implementation of the image recognition-based startup method as described below.

Generating a movement image signal (step S10) entails capturing a user's behavior action, such as shaking one's head, opening one's eyes, closing one's eyes, or blinking, by the capturing unit 11, so as to generate and send a movement image signal to the image recognition unit 12. When a behavior action thus captured is a facial action, the movement image signal is a facial movement image signal, such as a head-shaking image signal indicative of shaking one's head laterally or a blinking image signal indicative of blinking.

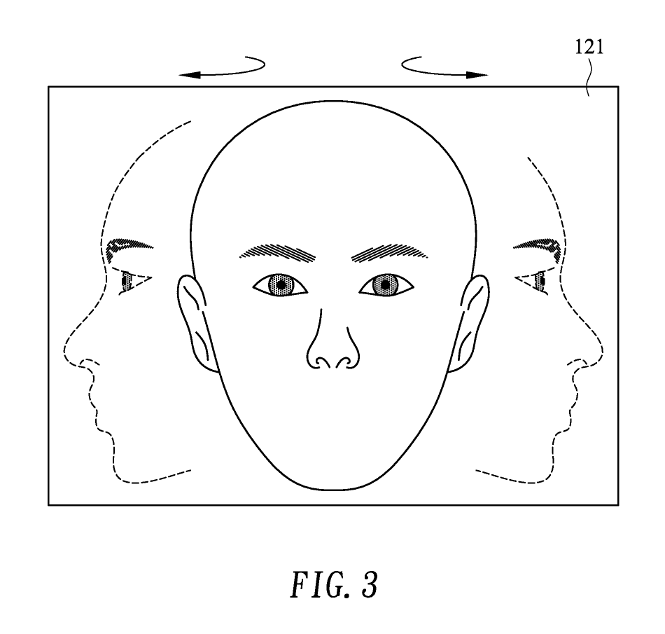

Referring to FIG. 3, generating a behavior recognition signal (step S30) entails: reading the movement image signal by the image recognition unit 12; removing noise from the movement image signal; and analyzing the consecutive movement image signals by image differentiation to obtain the user's behavior action range. For example, if the user shakes his or her head, there will be variation in the user's overall facial range between an image thereof and the next image thereof; hence, it can be determined that the user's behavior action range is defined as a head-shaking range 121. Afterward, the user's behavior recognition takes place, wherein if both the user's behavior action range determined by the image recognition unit 12 and the startup action-related behavior action range defined by the image recognition system 10 are the head-shaking range 121, a startup control signal will be generated.

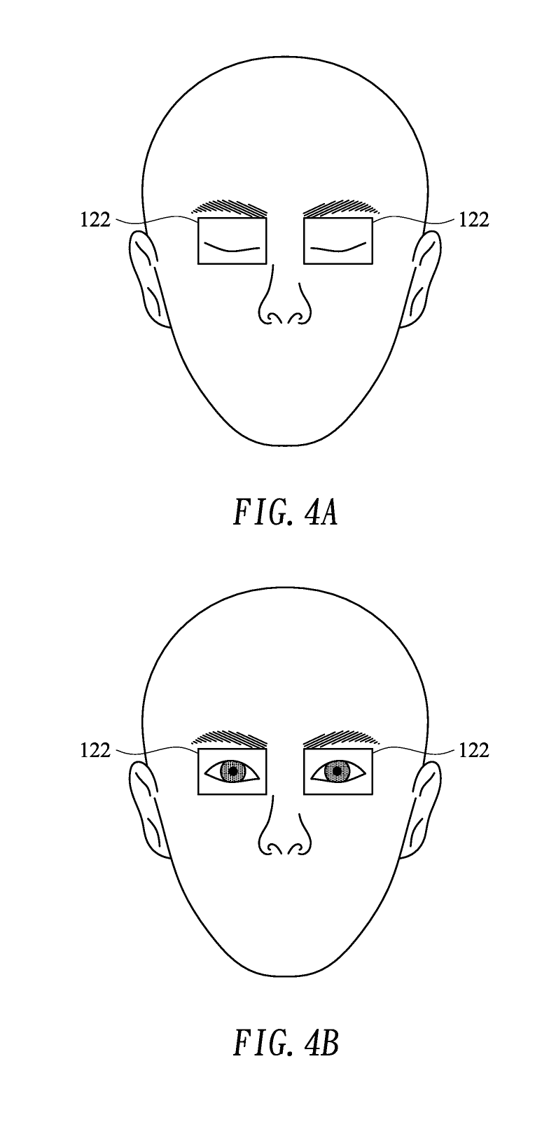

Referring to FIG. 4A and FIG. 4B, for example, if the user blinks, there will be variation in the user's ocular range between an image thereof and the next image thereof; hence, it can be determined that the user's behavior action range is defined as a blinking range 122. Afterward, the user's behavior recognition takes place, wherein if both the user's behavior action range determined by the image recognition unit 12 and the startup action-related behavior action range defined by the image recognition system 10 are the blinking range 122, a startup control signal will be generated. If the startup action-related behavior action range defined by the image recognition system 10 is defined as a head-shaking range 121, but the user's behavior action range determined by the image recognition unit 12 is defined as a blinking range 122 and thus differs from the startup action-related behavior action range defined by the image recognition system 10, the startup control signal will not be generated. When the information apparatus 100 is in a shutdown state, the startup control signal is a boot startup control signal. When the information apparatus 100 is in a hibernation state, the startup control signal is an awakening startup control signal.

Performing an apparatus startup (step S50) entails reading by the information apparatus 100 the startup control signal generated from the image recognition unit 12 so as to instruct the information apparatus 100 to perform a startup action. If the startup control signal read by the information apparatus 100 is a boot startup control signal, the information apparatus 100 can perform a boot startup action. If the startup control signal read by the information apparatus 100 is an awakening startup control signal, the information apparatus 100 can perform an awakening startup action.

The features of the present invention are disclosed above by the preferred embodiments to allow persons skilled in the art to gain insight into the contents of the present invention and implement the present invention accordingly. The preferred embodiments of the present invention should not be interpreted as restrictive of the scope of the present invention. Hence, all equivalent modifications or amendments made to the aforesaid embodiments should fall within the scope of the appended claims.

What is claimed is:

1. An image recognition-based startup method for use in an information apparatus having an image recognition system, the image recognition system comprising at least a capturing unit and an image recognition unit electrically connected to an output end of the capturing unit, the startup method comprising the steps of:
generating a movement image signal, including capturing a user's behavior action by the capturing unit to generate a movement image signal;
generating a behavior recognition signal, including reading the movement image signal by the image recognition unit and performing behavior recognition on the movement image signal to generate a startup control signal; and
performing an apparatus startup, including reading the startup control signal by the information apparatus to instruct the information apparatus to perform a startup action.

2. The startup method of claim 1, wherein the information apparatus is a nap zapper, a cell phone, a TV set, or a computer.

3. The startup method of claim 1, wherein the capturing unit is a camcorder.

4. The startup method of claim 1, wherein the movement image signal is a facial movement image signal.

5. The startup method of claim 4, wherein the facial movement image signal is a head-shaking image signal indicative of shaking one's head laterally.

6. The startup method of claim 4, wherein the facial movement image signal is a blinking image signal indicative of blinking

7. The startup method of claim 1, wherein the startup control signal is a boot startup control signal.

8. The startup method of claim 1, wherein the startup action is a boot startup action.

9. The startup method of claim 1, wherein the startup control signal is an awakening startup control signal.

10. The startup method of claim 1, wherein the startup action is an awakening startup action.
